(19) United States
(12) Patent Application Publication
(10) Pub. No.: US 2024/0256978 A1
(43) Pub. Date: Aug. 1, 2024

(54) METHODS AND APPARATUS FOR A STATISTICALLY OPTIMIZED LEARNING FRAMEWORK OFFERING BIAS MITIGATION

(71) Applicant: Intel Corporation, Santa Clara, CA (US)

(72) Inventors: Shekar Ramachandran, Bengaluru (IN); Rupali Agrahari, Sultanpur (IN); Himanshu Singh, Bangalore (IN); Rudra Nath Palit, Kolkata (IN); Anmol Bhasin, Bengaluru (IN)

(21) Appl. No.: 18/618,925

(22) Filed: Mar. 27, 2024

(51) Int. Cl. G06N 20/00

(52) U.S. Cl. CPC G06N 20/00

(57) ABSTRACT

An example apparatus disclosed includes interface circuitry, machine readable instructions, and programmable circuitry to at least one of execute or instantiate the machine readable instructions to send a global model to one or more collaborator models, the one or more collaborator models training on a local dataset associated with a collaborator model, receive one or more collaborator models trained on the local dataset, compute a similarity measurement between the global model and at least one collaborator model, determine aggregation for the global model based on the computed similarity measurement, aggregate one or more one or more collaborator models based on the determined aggregation, and update the global model based on the aggregation.

### FIELD OF THE DISCLOSURE

This disclosure relates generally to software processing, and, more particularly, to methods and apparatus for a statistically optimized learning framework offering bias mitigation.

### BACKGROUND

Artificial intelligence (AI)-based models rely on access to diverse annotated datasets for model training. However, such datasets can be too large or too sensitive to transmit to centralized servers for training of machine learning models. Federated learning (FL) presents a computational approach for project-based collaborations seeking to eliminate sensitive information (e.g., patient records, financial transactions, etc.) when training AI models.

### BRIEF DESCRIPTION OF THE DRAWINGS

FIG. 1 is an example logical flow of federated learning.

FIG. 2 is an example logical flow of federated learning using a statistically optimized learning framework offering bias mitigation, including federated learning framework organizer circuitry.

FIG. 3 illustrates distribution of weights in a pretrained deep learning model and a normal distribution associated with the pretrained model.

FIG. 4 illustrates an example architecture of the pretrained deep learning model used in combination with the statistically optimized learning framework of FIG. 2.

FIG. 5A illustrates an example dataset of augmentations for a CIFAR-10 dataset.

FIG. 5B illustrates an example dataset of augmentations for a MNIST and MNIST-FASHION dataset.

FIG. 5C illustrates an example dataset of federated and training configurations.

FIG. 6A illustrates an example comparative analysis of accuracy in a biased scenario.

FIG. 6B illustrates an example comparative analysis of accuracy in a biased scenario for a MNIST dataset.

FIG. 6C illustrates an example comparative analysis of accuracy in a biased scenario for a MNIST-Fashion dataset.

FIG. 6D illustrates an example comparative analysis of F1 scores in a biased scenario.

FIG. 7 illustrates an example variation of z-test values in aggregation rounds.

FIG. 8A illustrates an example comparative analysis of test accuracy between a traditional federated learning method and federated learning using the statistically optimized learning framework of FIG. 2.

FIG. 8B illustrates an example comparative analysis of differences in floating point operations between a traditional federated learning method and federated learning using the statistically optimized learning framework of FIG. 2.

FIG. 8C illustrates an example comparative analysis of network data transfers between a traditional federated learning method and federated learning using the statistically optimized learning framework of FIG. 2.

FIG. 9 illustrates an example graphical comparative analysis of network and resource optimization between a traditional federated learning method and federated learning using the statistically optimized learning framework of FIG. 2.

FIG. 10 is a block diagram representative of the federated learning framework organizer circuitry of FIG. 2.

FIG. 11 is a flowchart representative of example machine-readable instructions and/or example operations that may be executed, instantiated, and/or performed by example programmable circuitry to implement the example federated learning framework organizer circuitry of FIG. 2.

FIG. 12 is a flowchart representative of example machine-readable instructions and/or example operations that may be executed, instantiated, and/or performed by example programmable circuitry to implement the example federated learning framework organizer circuitry of FIG. 2 to determine model convergence using a statistical significance test.

FIG. 13 is a flowchart representative of example machine-readable instructions and/or example operations that may be executed, instantiated, and/or performed by example programmable circuitry to implement the example federated learning framework organizer circuitry of FIG. 2 to perform quantification of data bias during aggregation.

FIG. 14 is a block diagram of an example processing platform including programmable circuitry structured to execute, instantiate, and/or perform the example machine readable instructions and/or perform the example operations of FIGS. 11-13 to implement the federated learning framework organizer circuitry of FIG. 2.

FIG. 15 is a block diagram of an example implementation of the programmable circuitry of FIG. 14.

FIG. 16 is a block diagram of another example implementation of the programmable circuitry of FIG. 14.

FIG. 17 is a block diagram of an example software/firmware/instructions distribution platform (e.g., one or more servers) to distribute software, instructions, and/or firmware (e.g., corresponding to the example machine readable instructions of FIGS. 11-13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Training artificial intelligence (AI)-based models can require the use of datasets that include sensitive information (e.g., protected health information, financial transactions, etc.). Transmission of datasets to centralized servers for training machine learning models occurs during multi-site collaborations. Federated Learning (FL) deployments can be used for AI model-based training in settings involving sensitive data (e.g., healthcare and financial sectors). For example, FL is a machine learning approach focusing on settings in which multiple entities collaboratively train a model while maintaining decentralized data. In AI-based projects associated with FL, the objective is to develop a shared model without compromising individual training data privacy. However, the decentralized methodology of FL presents notable challenges, primarily revolving around the efficient utilization of computational resources, network traffic, and the emergence of data bias.

For example, FL necessitates continual aggregation whenever a collaborator possesses a new model. However, insignificant model updates may be transmitted, needlessly burdening network bandwidth and computational resources. Efficiently managing these resources while ensuring model accuracy is a significant concern. Additionally, a pivotal aspect of FL is automated aggregation at the request of the collaborator(s). However, determining a number of aggregation rounds for the aggregator model to converge without human intervention is a challenge. The dynamic nature of data distribution among collaborators renders static termination conditions inefficient, potentially leading to suboptimal aggregation, resource waste, and/or diminished model performance. Likewise, preserving data privacy is fundamental in FL, achieved by preventing direct data access by the central aggregator. Collaborators, in charge of addressing label bias, send locally trained models to the aggregator for aggregation into a global model. However, a biased model from even a single collaborator can propagate biases throughout the network via the global model, adversely affecting model fairness and accuracy.

While various libraries (e.g., such as OpenFL, PySyft, and Flower) have been introduced for implementing FL, these implementations are in a relatively early stage and primarily inherit their optimization approaches from centralized learning. Consequently, these implementations have not sufficiently mitigated the challenges related to excessive utilization of computational and network resources unique to FL. Known approaches have also explored the impact of data bias in FL, underlining the detrimental effect of data bias on model quality. For example, attempts to mitigate bias include collaborator-centric bias handling or partial sharing of data metrics with the aggregator, such as sharing an encrypted version of the collaborator data distribution with the aggregator for enhanced security. However, in practical scenarios, a biased model from any collaborator, whether intentional or not, can contaminate the entire network. Consequently, effective server-side control is crucial to manage bias propagation. Moreover, sharing collaborator data metrics with the aggregator poses privacy risks, conflicting with FL-based principles. Although some known approaches propose the use of encryption, a compromised aggregator could still lead to privacy breaches.

Methods and apparatus disclosed herein introduce a statistically optimized learning framework offering bias mitigation. In examples disclosed herein, an FL-based framework introduces an adaptive early-stopping mechanism grounded in statistical significance tests. As such, methods and apparatus disclosed herein automatically ascertain the number of aggregation-based rounds essential for the global model to converge, eliminating the need for manual intervention. In examples disclosed herein, a mathematical factor is introduced that precisely quantifies the level of data bias within a collaborator dataset. This factor enables the seamless implementation of various pioneering bias mitigation strategies while upholding stringent data privacy standards. In examples disclosed herein, computational resource efficiency is maximized while preserving model metrics with either no degradation or minimal degradation. Methods and apparatus disclosed herein introduce a statistical early stopping criterion to detect model convergence, achieving a reduction of 31.41% in Floating Point Operations (FLOPs) usage and 35% fewer network requests compared to conventional frameworks. Additionally, a bias factor introduced herein enables control over bias in the aggregator model without compromising data privacy, a feature unavailable in any other conventional framework.

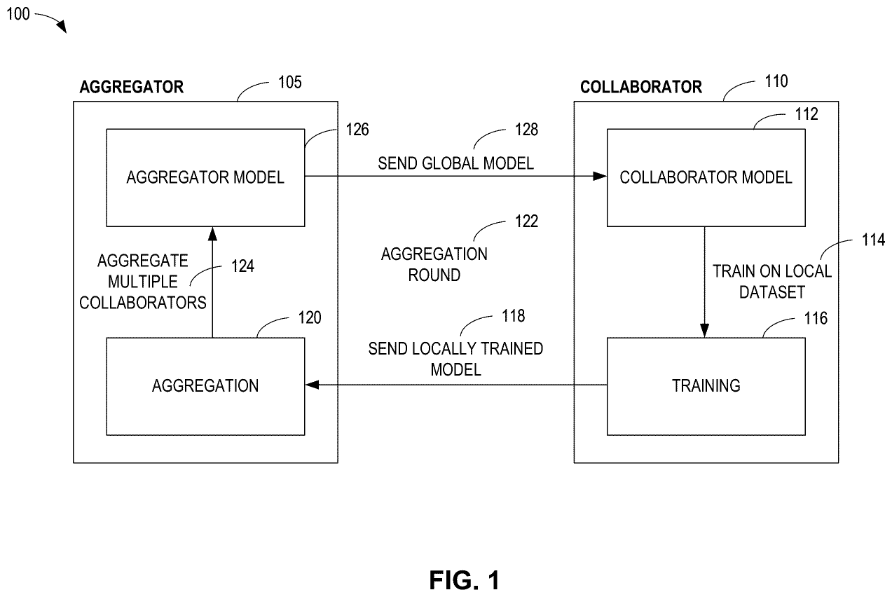

FIG. 1 is an example logical flow 100 of Federated Learning (FL). In FL, a single AI model can be trained using multiple datasets (e.g., belonging to different devices and/or organizations) without any of the raw datasets being shared. In contrast to traditional machine learning approaches, FL does not rely on centralized datasets that are uploaded to a central server. Instead, the model is trained on local data, such that only model updates are shared with the central server, promoting privacy-preserving and decentralized model training. The FL-based logical flow of FIG. 1 includes an example aggregator 105 and an example collaborator 110. The collaborator 110 includes an example collaborator model 112 and training 116. The aggregator 105 includes example aggregation 120 and an example aggregator model 126. For example, the collaborator 110 includes collaborator model(s) 112 that are trained on a local dataset (e.g., train on local dataset 114). The locally trained model is sent for aggregation (e.g., send locally trained model 118), resulting in the aggregation of multiple locally trained models received from the collaborator(s) 110 as part of an aggregation round 122. The aggregated locally trained model(s) (e.g., aggregate multiple collaborators 124) are passed to the aggregator model 126, which generates a global model that is sent back to the collaborator(s) 110 (e.g., send global model 128). For example, the aggregation 120 includes an aggregation algorithm that aggregates knowledge obtained by the collaborator(s) 110 after training 116 with their local data and using the aggregated knowledge to update the global model (e.g., as part of the aggregation round(s) 122). In the example of FIG. 1, a central server (e.g., aggregator 105) manages the connections between the entities in the FL environment (e.g., collaborator(s) 110) and/or aggregates the knowledge obtained by the FL collaborator(s) 110. In the example of FIG. 1, the collaborator(s) 110 include computing devices with data that can be used for training the global model (e.g., personal computers, servers, smart devices, computerized sensor devices, etc.).

For example, the central server receives a connection from the collaborator(s) 110 and sends the collaborator(s) 110 the initial global model (e.g., send global model 128). The collaborator(s) 110 train the initial global model with their local data (e.g., train on local dataset 114) and send the trained model back to the central server (e.g., aggregator 105), which receives the locally trained models and aggregates them using the aggregation algorithm (e.g., using aggregation 120). The aggregator 105 updates the global model based on the aggregation results and sends the updated global model version to the collaborator(s) 110, repeating the aggregation round(s) 122 until the model converges and/or until the aggregator 105 stops the aggregations.

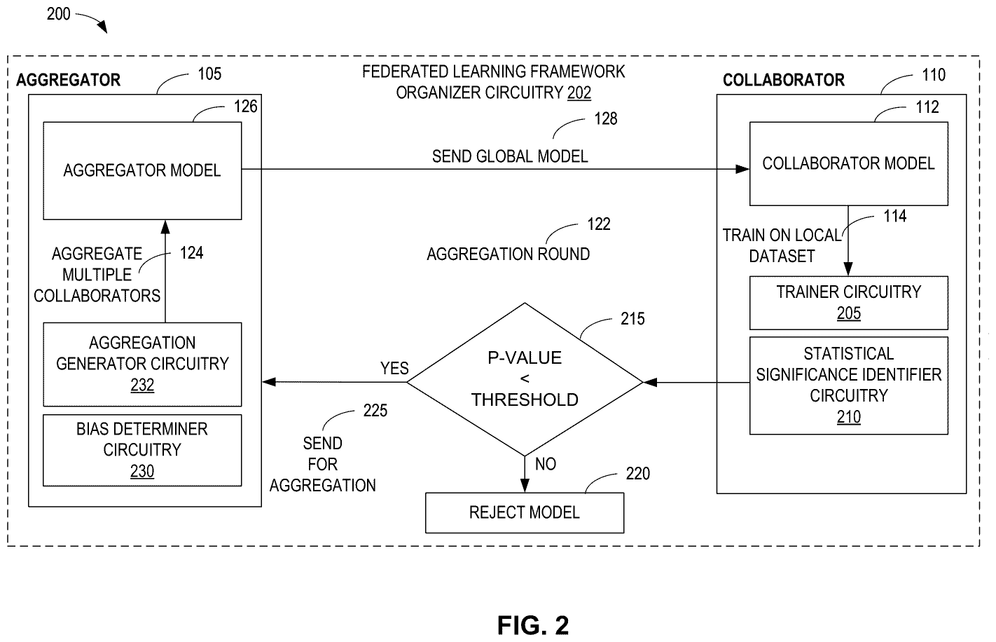

While in standard FL-based aggregation algorithms the training rounds are initiated by the aggregator 105 upon receipt of new locally trained models from a minimum number of collaborator(s) 110, determining accurate thresholds for iteration or accuracy in FL is challenging due to various factors (e.g., dynamic nature of data distribution among collaborator(s) 110, absence of a human element for threshold determination in an automated online process, difficulty in determining thresholds without knowledge of aggregator data, etc.). Furthermore, due to a decentralized nature and limited contribution, FL presents other challenges associated with the efficient utilization of computational resources, network traffic, and emergence of data bias. Methods and apparatus disclosed herein introduce a dynamic methodology to determine model convergence effectively, as described in more detail in connection with FIG. 2. For example, methods and apparatus disclosed herein optimize the allocation of computational and network resources through a statistical estimation of aggregation rounds, promoting markedly efficient and cost-effective operations. Furthermore, methods and apparatus disclosed herein defend against data bias associated with collaborators' contributions by introducing a bias factor that establishes a resilient defense mechanism, substantially enhancing model reliability and accuracy. This enhancement is particularly significant in the realm of targeted advertising, where precision and impartiality are paramount.

FIG. 2 is an example FL logical flow 200 using a statistically optimized learning framework offering bias mitigation, including example FL framework organizer circuitry 202. In the example of FIG. 2, the FL framework organizer circuitry 202 includes the aggregator 105, the collaborator 110, the collaborator model 112, and the aggregator model 125 of FIG. 1. Additionally, the FL framework organizer circuitry 202 includes example trainer circuitry 205, example statistical significance identifier circuitry 210, example bias determiner circuitry 230, and example aggregation generator circuitry 232. In the example of FIG. 2, the trainer circuitry 205 trains the collaborator model 112 on a local dataset (e.g., train on local dataset 114), as described in connection with FIG. 1. The statistical significance identifier circuitry 210 initiates a Z-test-based model significance identification to dynamically adjust the required aggregation rounds (e.g., aggregation round(s) 122) for aggregator model 126 convergence. For example, when a p-value falls within the significance threshold (e.g., p-value<threshold at 215), the collaborator 110 can send the collaborator model 112 trained using the trainer circuitry 205 for ongoing or initial aggregation rounds (e.g., send for aggregation 225). Conversely, if the statistical significance identifier circuitry 210 determines that the Z-test yields a p-value surpassing the significance threshold, the collaborator model 112 is deemed insignificant and rejected (e.g., reject model 220), discontinuing the aggregation iteration chain or allowing an early exit for non-contributing collaborator(s) 110. Utilizing the p-value as a threshold is advantageous due to the use of a bounded range (e.g., [0,1]), ensuring a uniform threshold for model evaluation during aggregation (e.g., using the aggregator 105).

In the example of FIG. 2, the statistical significance identifier circuitry 210 identifies the p-value based on a z-statistic. Statistical significance tests play a crucial role in assessing research result reliability, discerning meaningful differences or relationships from chance occurrences. In the context of collaborator 110 contributions, a null hypothesis (H₀) and an alternate hypothesis (Ha) is identified, comparing the current collaborator model 112 with the last aggregated model (e.g., aggregator model 126). For example, the null hypothesis (H₀) can be represented as “H₀: The current collaborator model and the last aggregated model are identical”, while the alternate hypothesis (Ha) can be represented as “Ha: The current collaborator model and the last aggregated model are different”. Validation of the null hypothesis indicates training saturation, while a significantly different model necessitates aggregation for a new global model. This approach allows for precise determination of model convergence, guiding the aggregation process until the alternate hypothesis holds true. To conduct this comparison, the statistical significance identifier circuitry 210 uses a two-sample z-test, considering the weight distribution's normal approximation before and after local training by the law of large numbers. The statistical significance identifier circuitry 210 applies the z-statistic as a test metric, evaluating the truth of the null hypothesis as shown in connection with Equation 1:

$$z = \frac{( {\overline{x}}_{1} - {\overline{x}}_{2} )}{\sqrt{[ ( \frac{{σ}_{1}^{2}}{{n}_{1}} ) + ( \frac{{σ}_{2}^{2}}{{n}_{2}} ) ]}} \qquad Equation 1$$

In the example of Equation 1, x̅₁ and x̅₂ represent means of the last aggregated model weights and the current collaborator model weights, respectively, while σ₁ and σ₂ are the standard deviations of the last aggregated model weights and the current collaborator model weights, respectively, while n₁ and n₂ are the number of weights in the aggregator and collaborator models, respectively. In examples disclosed herein, the p-value is the probability of obtaining a z-statistic as extreme as that observed under the null hypothesis (H₀). As such, the p-value of 1 corresponds to 100% confidence in the null hypothesis, which signifies a 100% similarity between the collaborator and the aggregator models (e.g., a similarity measurement between the collaborator and aggregator models based on an average value comparison). Therefore, statistical significance identifier circuitry 210 presets a significance threshold for aggregation and considers the collaborator model contribution to be statistically insignificant if the p-value surpasses the threshold or statistically significant if the p-value falls within the threshold.

In the example of FIG. 2, the bias determiner circuitry 230 identifies a bias factor to quantify data bias. For example, FL models can suffer from label bias due to their decentralized nature, affecting fairness and accuracy. Unlike centralized training, where bias control is more manageable, FL's privacy constraints hinder detailed dataset sharing with the aggregator 105. Methods and apparatus disclosed herein address this existing challenge by identifying a bias factor, which is a privacy-centric assessment of label bias that can be performed without divulging sensitive dataset specifics. As a mathematically derived and normalized factor, the bias factor prevents dataset reverse-engineering. For example, given a dataset with c classes and total data samples (nₜ), such that each class contains n₁, n₂, . . . , n_{c} data samples, the bias determiner circuitry 230 determines ideal samples per class (n_{ideal}) for the dataset to be unbiased (e.g., in accordance with Equation 2) and identifies a bias (b) in accordance with Equation 3 (e.g., using L²-Norm):

$${n}_{ideal} = \frac{{n}_{t}}{c} \qquad Equation 2$$

$$b = {( {n}_{ideal} - {n}_{1} )}^{2} + {( {n}_{ideal} - {n}_{2} )}^{2} + … + {( {n}_{ideal} - {n}_{c} )}^{2} = {\sum }_{i = 1}^{c} {( {n}_{ideal} - {n}_{i} )}^{2} \qquad Equation 3$$

Since the bias (b) is an element of all real numbers (e.g., b∈ [symbol] ₀⁺), a scaling factor k can be introduced to bound the value within [0,1], resulting in the determination of a bias factor (β), which can be defined in accordance with Equation 4, while the value of k can be determined in accordance with Equation 5:

$$β = \frac{b}{k} = \frac{1}{k} {\sum }_{i = 1}^{c} {( {n}_{ideal} - {n}_{i} )}^{2} \qquad Equation 4$$

$$k = max ( {\sum }_{i = 1}^{c} {( {n}_{ideal} - {n}_{i} )}^{2} ) \qquad Equation 5$$

In connection with Equation 5, the bias determiner circuitry 230 sets (n_{ideal}−nᵢ) to equal aᵢ∀i∈{1 . . . c}, such that nᵢ=(n_{ideal}−aᵢ) and aᵢ∈{0 . . . n_{ideal}} if nᵢ∈ [symbol] ₀⁺. Moreover, the bias determiner circuitry 230 determines the value of k in accordance with Equations 6-10, as shown below:

$${\sum }_{i = 1}^{c} {n}_{i} = {n}_{t} \qquad Equation 6$$

$${\sum }_{i = 1}^{c} ( {n}_{ideal} - {a}_{i} ) = {cn}_{ideal} \qquad Equation 7$$

$${a}_{c} = - {\sum }_{i = 1}^{c - 1} {a}_{i} \qquad Equation 8$$

$$k = max \{ {a}_{1}^{2} + … + {a}_{c - 1}^{2} + {( {a}_{1} + … + {a}_{c - 1} )}^{2} \} = max \{ {\sum }_{i = 1}^{c - 1} {a}_{i}^{2} + {( {\sum }_{i = 1}^{c - 1} {a}_{i} )}^{2} \} \qquad Equation 9$$

$$k = {n}_{ideal}^{2} \times max \{ {\sum }_{i = 1}^{c - 1} {α}_{i}^{2} + {( {\sum }_{i = 1}^{c - 1} {α}_{i} )}^{2} \} \qquad Equation 10$$

In the example of Equation 8, the bias determiner circuitry 230 defines the variable aᵢ as aᵢ/n_{ideal}, such that αᵢ∈[0,1]∀i∈{1 . . . c}. Furthermore, if N(.) is a function denoting the total number of terms in an expression and a; represents an upper boundary of 1, Equation 10 can be simplified into Equation 17, as shown below using Equations 11-16:

$$k = {n}_{ideal}^{2} \times N ( {\sum }_{i = 1}^{c - 1} {α}_{i}^{2} + {( {\sum }_{i = 1}^{c - 1} {α}_{i} )}^{2} ) \qquad Equation 11$$

$$k = {n}_{ideal}^{2} \times N ( 2 {\sum }_{i = 1}^{c - 1} {α}_{i}^{2} + 2 {\sum }_{i = 1 , j > i}^{c - 1} {α}_{i} {α}_{j} ) \qquad Equation 12$$

$$k = 2 {n}_{ideal}^{2} \times \{ N ( {\sum }_{i = 1}^{c - 1} {α}_{i}^{2} ) + N ( {\sum }_{i = 1 , j > i}^{c - 1} {α}_{i} {α}_{j} ) \} \qquad Equation 13$$

$$k = 2 {n}_{ideal}^{2} \times \{ ( c - 1 ) + ( {(}^{c - 1} ) {C}_{2} ) \qquad Equation 14$$

$$k = 2 {n}_{ideal}^{2} \times \{ ( c - 1 ) + \frac{( c - 1 ) ( c - 2 )}{2} \} \qquad Equation 15$$

$$k = 2 {n}_{ideal}^{2} \times \{ \frac{c ( c - 1 )}{2} \} \qquad Equation 16$$

$$k = {n}_{ideal}^{2} c ( c - 1 ) \qquad Equation 17$$

As such, the bias factor can be expressed in accordance with Equation 18 through the substitution of Equation 17 into Equation 4:

$$β = \frac{1}{{n}_{ideal}^{2} c ( c - 1 )} {\sum }_{i = 1}^{c} {( {n}_{ideal} - {n}_{i} )}^{2} \qquad Equation 18$$

In examples disclosed herein, the bias determiner circuitry 230 identifies the boundary conditions associated with the bias factor. For example, the bias determiner circuitry 230 identifies a first boundary condition related to the dataset being ideally balanced, as shown in accordance with Equation 19:

$${n}_{ideal} = {n}_{i} = \frac{{n}_{t}}{c} ∀ i ∈ \{ 1 … c \} \qquad Equation 19$$

Under the first condition, the value of the bias factor (β) is identified using Equation 20:

$$β = \frac{1}{{n}_{ideal}^{2} c ( c - 1 )} {\sum }_{i = 1}^{c} {( {n}_{ideal} - {n}_{i} )}^{2} = 0 \qquad Equation 20$$

Additionally, the bias determiner circuitry 230 identifies a second boundary condition. For example, when the dataset is highly unbalanced, all the data is present under one class only

$$( e . g . , {n}_{i} = \{ \begin{matrix}0 , & i ∈ \{ 1 … ( c - 1 ) \} \\ {n}_{t} & i = c\end{matrix} ) .$$

Under such a scenario, the bias determiner circuitry 230 identifies the value of the bias factor (β) in accordance with Equations 21-25:

$$β = \frac{1}{{n}_{ideal}^{2} c ( c - 1 )} {\sum }_{i = 1}^{c} {( {n}_{ideal} - {n}_{i} )}^{2} \qquad Equation 21$$

$$β = \frac{1}{{n}_{ideal}^{2} c ( c - 1 )} [ ( c - 1 ) {n}_{ideal}^{2} + {( {n}_{ideal} - {n}_{c} )}^{2} ] \qquad Equation 22$$

$$β = \frac{1}{{n}_{ideal}^{2} c ( c - 1 )} [ ( c - 1 ) {n}_{ideal}^{2} + {( {n}_{ideal} - c {n}_{ideal} )}^{2} ] \qquad Equation 23$$

$$β = \frac{1}{{n}_{ideal}^{2} c ( c - 1 )} ( c - 1 ) {n}_{ideal}^{2} [ 1 + ( c - 1 ) ] \qquad Equation 24$$

$$β = 1 \qquad Equation 25$$

As such, the value of the proposed bias factor (β) lies between [0,1], where 0 denotes the ideal scenario of a completely balanced dataset and 1 depicts the presence of a strong bias.

In examples disclosed herein, the aggregation generator circuitry 232 identifies aggregation algorithms leveraging the bias factor identified using the bias determiner circuitry 230. For example, the bias factor serves as a normalized metric and is instrumental for bias detection in collaborator model(s) 112. This valuable insight enables server-side implementation of effective bias control mechanisms to regulate bias propagation from the collaborator model(s) 112 to the aggregator model 126. For example, the aggregation generator circuitry 232 identifies aggregation algorithms based on the bias factor, including (1) bias thresholding, (2) a bias weighted federated averaging (FedAvg)-based algorithm, and (3) hybrid aggregation. In examples disclosed herein, bias thresholding involves setting a threshold (T) for the bias factor (β) to mitigate bias. For example, the aggregation generator circuitry 232 accepts collaborator model(s) 112 with bias factors within threshold T for aggregation (e.g., β≤T), while collaborator model(s) 112 exceeding the threshold (e.g., β>T) are rejected and replaced with the previously aggregated model, as shown in connection with Equation 26:

$$Model to Aggregate = \{ \begin{matrix}Collaborator Model , & β \leq T \\ Aggregator Model , & β > T\end{matrix} \qquad Equation 26$$

In examples disclosed herein, the aggregation generator circuitry 232 also identifies a bias weighted federated averaging-based algorithm. For example, recognizing the value of information even in biased models, bias weighted federated averaging modifies the federated averaging algorithm by using the bias factor (β) as a weight. The aggregation generator circuitry 232 assigns models for aggregation (M) with lower bias higher weights, contributing more to the aggregation, while models with higher bias receive lower weights, as shown in connection with Equation 27:

$$Aggregator Model = \frac{1}{{\sum }_{i} ( 1 - {β}_{i} )} {\sum }_{i} \{ ( 1 - {β}_{i} ) {M}_{i} \} \qquad Equation 27$$

Furthermore, in examples disclosed herein, the aggregation generator circuitry 232 employs a hybrid aggregation approach to identify bias in collaborator model(s) 112. For example, the aggregation generator circuitry 232 combines bias threshold-based rejection and the bias weighted federated averaging to identify highly biased models using the threshold for rejection before aggregation. For example, the aggregation generator circuitry 232 aggregates models within an acceptable bias factor range using the weighted federated averaging algorithm, such that balanced dataset models (e.g., based on the bias factors associated with the models) are prioritized.

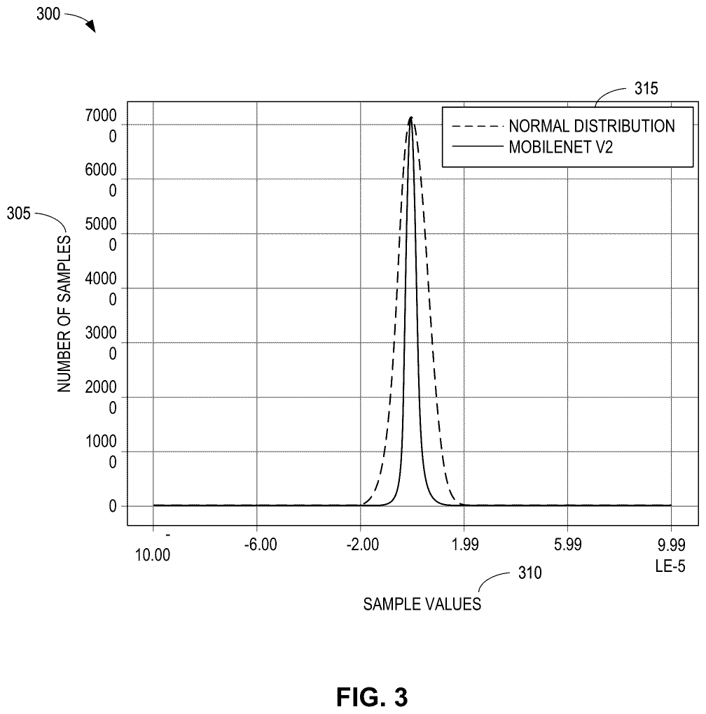

FIG. 3 illustrates an example graphical representation 300 showing distribution of weights in a pretrained deep learning model (e.g., MobileNet v2) and a normal distribution associated with the pretrained model. The graphical representation 300 includes an example number of samples 305, an example number of sample values 310, and an example identification of the type of distribution (e.g., normal distribution or pretrained deep learning model distribution). For example, the distribution of weights in the pretrained model (e.g., MobileNet v2) and the normal distribution includes a mean of 2.87×10⁻⁷ and a variance of 3.17×10⁻¹¹. For example, as described in connection with FIG. 2, the statistical significance identifier circuitry 210 uses a two-sample z-test as part of a statistical significance test identifying model-based training saturation. For example, the statistical significance identifier circuitry 210 identifies the weight distribution's normal approximation before and after local training of a collaborator model, such that the z-statistic is used to evaluate the truth of the null hypothesis (e.g., similarity between the current collaborator model and the last aggregated model). For example, the statistical significance identifier circuitry 210 applies the law of large numbers, which states that as a sample size grows, the mean of the sample size comes closer to the average of the whole population, given that the sample becomes more representative of the population as the sample increases in size.

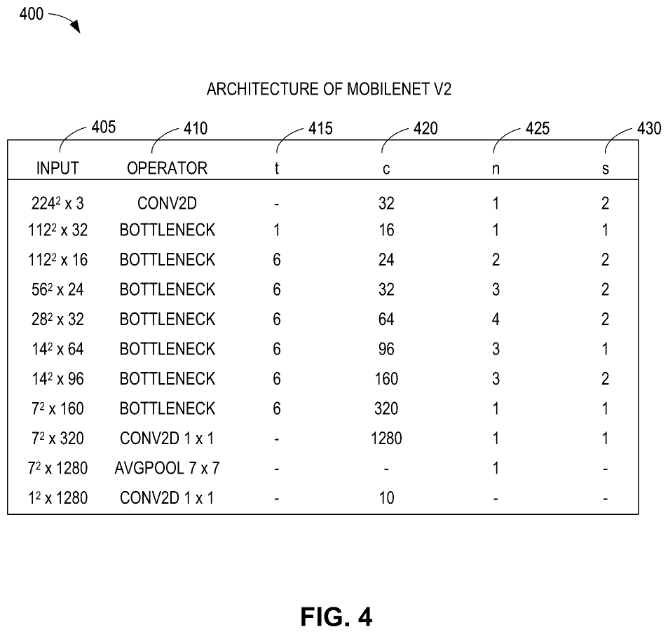

FIG. 4 illustrates an example architecture 400 of the pretrained deep learning model (e.g., MobileNet v2) used in combination with the statistically optimized learning framework of FIG. 2. In examples disclosed herein, the performance of the statistically optimized learning framework of FIG. 2 (OptiStat FL) is compared with traditional federated learning frameworks. For example, when using the MobileNet v2 deep learning model with various datasets (e.g., CIFAR-10, MNIST-Fashion, and MNIST Dataset), OptiStat FL exhibited a systematic, mathematical approach to federated learning, offering advantages regardless of model or dataset specifics. MobileNet v2, known for efficient image classification in resource-constrained devices, is ideal for federated learning, aligning with the training needs on low-power edge devices. The model's final fully connected linear layer is modified to accommodate CIFAR-10, MNIST, and MNIST-Fashion dataset classes, as shown in FIG. 4. Two sets of experiments to compare the performance of OptiStat FL with conventional federated learning frameworks were performed utilizing the MobileNet v2 deep learning model with the CIFAR-10, MNIST-Fashion and MNIST datasets. In the example of FIG. 4, the MobileNet v2 architecture includes an example input 405, an example operator 410, an example expansion factor (1) 415, an example number of output channels (c) 420, an example repeating number (n) 425, and an example stride (s) 430.

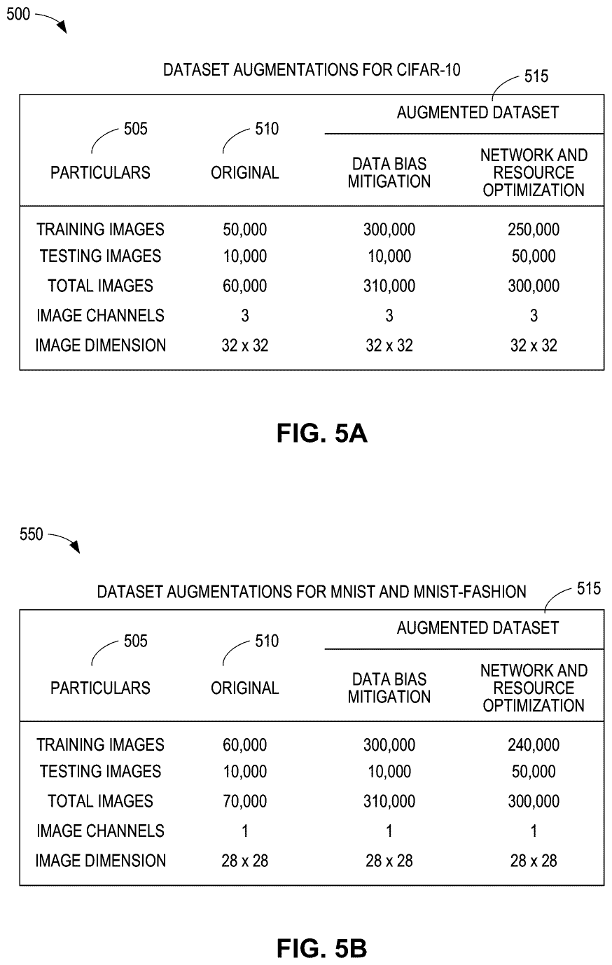

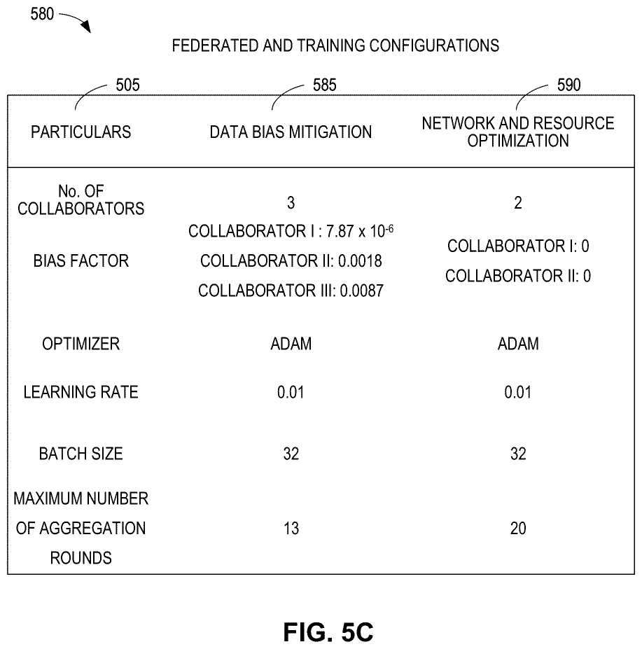

FIG. 5A illustrates an example dataset 500 of augmentations for a CIFAR-10 dataset. In the example of FIG. 5A, the CIFAR-10 dataset is used for data bias mitigation with the statistically optimized learning framework of FIG. 2. For example, to investigate the implications of data bias, the statistically optimized learning framework of FIG. 2 was validated using three well-known datasets (e.g., CIFAR-10, MNIST-Fashion and MNIST datasets). CIFAR-10, a robust dataset featuring 50,000 training and 10,000 testing images across 10 classes, was selected to investigate data bias mitigation effects. For example, the original CIFAR-10 training dataset was distributed among three collaborator(s) 110 with varying data biases. This dataset augmentation process involved replicating the CIFAR-10 training dataset six times while retaining the original test dataset, as shown in the example of FIG. 5A. Similar augmentation methods were applied to the MNIST and MNIST Fashion datasets for distribution among the three collaborator(s) 110, as shown in connection with FIG. 5B. All parameters, except the datasets, remained consistent. The goal of this experiment was to train various models, including (1) a centrally trained model trained for 13 epochs using a biased dataset with a bias factor of 0.0018, (2) a model trained through traditional federated learning (e.g., using the FedAvg algorithm) without any bias mitigation, (3) a model trained through bias thresholding with a fixed threshold of 0.05, (4) a model trained through federated learning using the proposed bias weighted FedAvg algorithm, and (5) a model trained through federated learning using the hybrid aggregation method with a threshold set at 0.05. In the example of FIG. 5A, the dataset augmentations for CIFAR-10 include example information related to the dataset images (e.g., particulars 505 showing data related to training images, testing images, total images, etc.), example original image size 510, and example augmented dataset type 515 (e.g., data bias mitigation dataset, network and resource optimization dataset). In examples disclosed herein, the datasets were used for optimizing networks and resources, requiring the dataset to be distributed among two collaborator(s) 112 without bias. In the example of FIG. 5A, the entire CIFAR-10 dataset was augmented five times using the same AutoAugment policy.

FIG. 5B illustrates an example dataset 550 of augmentations for a MNIST and MNIST-FASHION dataset. As described in connection with FIG. 5A, the MNIST and MNIST Fashion datasets underwent an augmentation process for distribution among three collaborator(s) 112. For example, data bias mitigation and network and resource optimization were performed using the MNIST and MNIST-FASHION datasets, with the results showing changes in the particulars 505 (e.g., training images, testing images, total images, image channels, and image dimensions), as compared to the original 510 values.

FIG. 5C illustrates an example dataset 580 of federated and training configurations. In the example of FIG. 5C, the federated and training configurations include particulars 505, example data bias mitigation results 585, and example network and resource optimization results 590. The particulars 505 include a number of collaborators, bias factor(s) associated with the collaborators, optimizers, learning rates, batch sizes, and a maximum number of aggregation rounds. In the example of FIG. 5C, the z-test threshold (a) was fixed at 0.97, and the collaborator models were aggregated using the FedAvg algorithm.

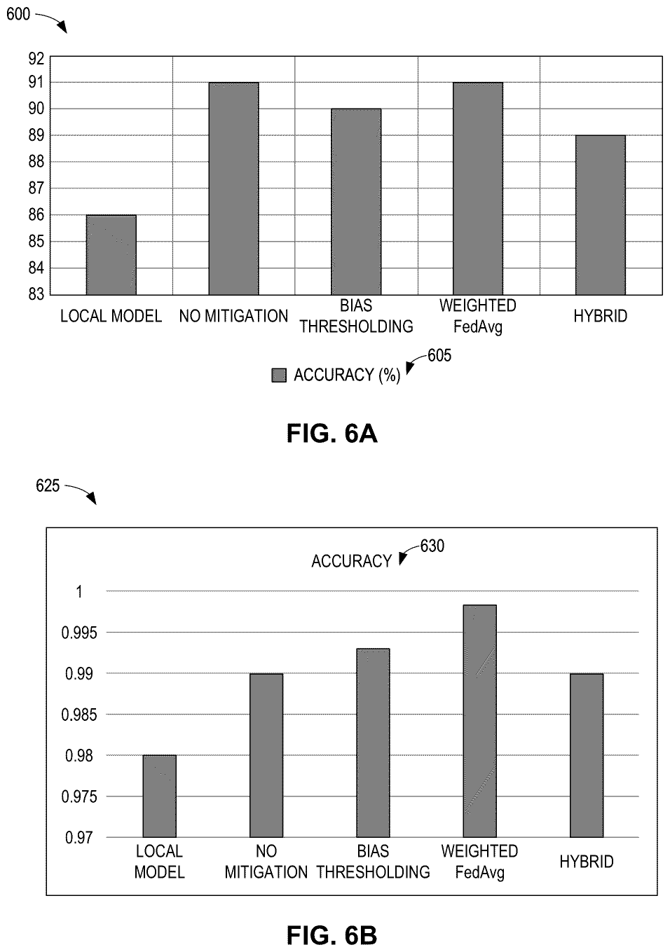

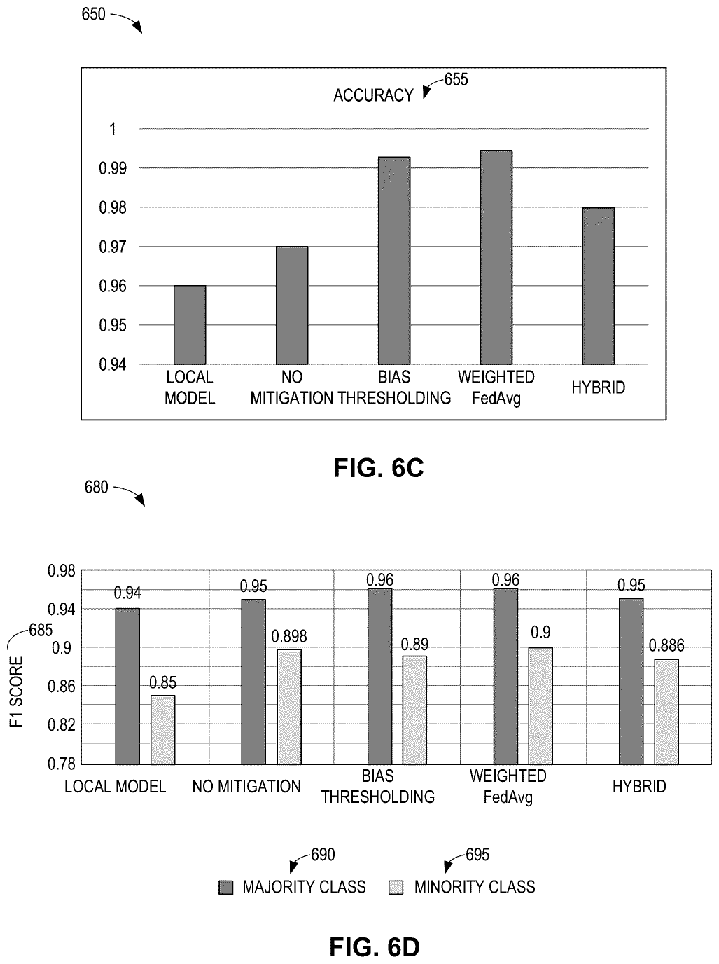

FIG. 6A illustrates an example accuracy-based comparative analysis 600 in a biased scenario, using data bias mitigation in the statistically optimized learning framework of FIG. 2. In the example of FIG. 6A, accuracy percentages 605 are compared when using a local model, no bias mitigation, bias thresholding, weighted federated averaging, and a hybrid aggregation, as described in connection with FIG. 2. When using the CIFAR-10 dataset, the local model training achieved an accuracy of 86%, noticeably lower than federated learning models, which averaged at an accuracy of 90.25%. As such, there is a benefit to using unbiased collaborators in federated learning over training locally on a biased dataset. Models aggregated without bias mitigation and using bias weighted federated averaging achieved the highest accuracies at 91%, surpassing hybrid aggregation and thresholding methods, as shown in FIG. 6A. As such, rejecting collaborators based on high bias reduces the number of knowledge sources available for learning, resulting in subpar models.

FIG. 6B illustrates an example accuracy-based comparative analysis 625 in a biased scenario for a MNIST dataset. As described in connection with FIG. 6A, example accuracy percentages 630 are compared when using a local model, no bias mitigation, bias thresholding, weighted federated averaging, and a hybrid aggregation. For MNIST, locally trained models attained 97.5% accuracy, lower than federated learning models, which had an average accuracy of 99.25%.

FIG. 6C illustrates an example accuracy-based comparative analysis 650 in a biased scenario for a MNIST-Fashion dataset. As previously described, example accuracy percentages 655 are compared when using a local model, no bias mitigation, bias thresholding, weighted federated averaging, and a hybrid aggregation. In the example of FIG. 6C, models with bias thresholding and weighted federated averaging achieved the highest accuracy percentages (over 99%). These results highlight that training on a biased dataset locally maintains the data bias, whereas learning in a federated setting can improve the model for biased collaborators.

FIG. 6D illustrates an example comparative analysis 680 of F1 scores in a biased scenario. The F1 score is a key classification model metric amalgamating precision and recall for overall performance assessment. In the example of FIG. 6D, the locally trained model shows a substantial F1 score gap between an example majority class 690 and an example minority class 695, indicating bias towards the majority class 690. Furthermore, models trained without bias mitigation and using bias weighted federated averaging exhibited minimal F1 score differences between the majority class 690 and the minority class 695. Among all models, bias weighted federated averaging achieved the highest F1 scores for both classes, showcasing the potential to outperform models with no mitigation even with similar accuracy.

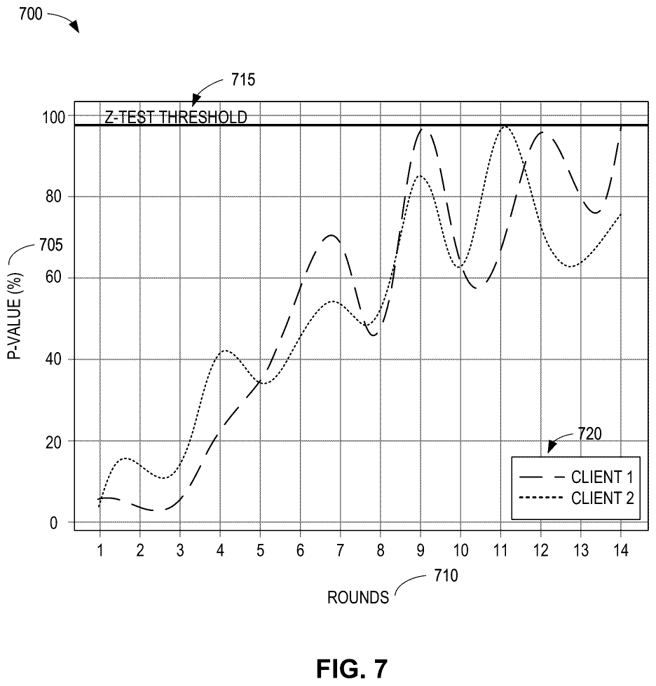

FIG. 7 illustrates an example variation 700 of z-test values in aggregation rounds as part of results obtained during network and resource optimization. FIG. 7 includes example p-value percentage values 705, example rounds 710, an example z-test threshold 715, and client identifiers 720. During experimentation, collaborator I (e.g., client 1) in the federated learning framework of OptiStat FL crosses the z-test threshold 715 at round 14, terminating any further aggregation. However, due to no early stopping criteria in the traditional federated learning (e.g., designated here as Plain FL), aggregation continues to the maximum number of rounds (e.g., 20).

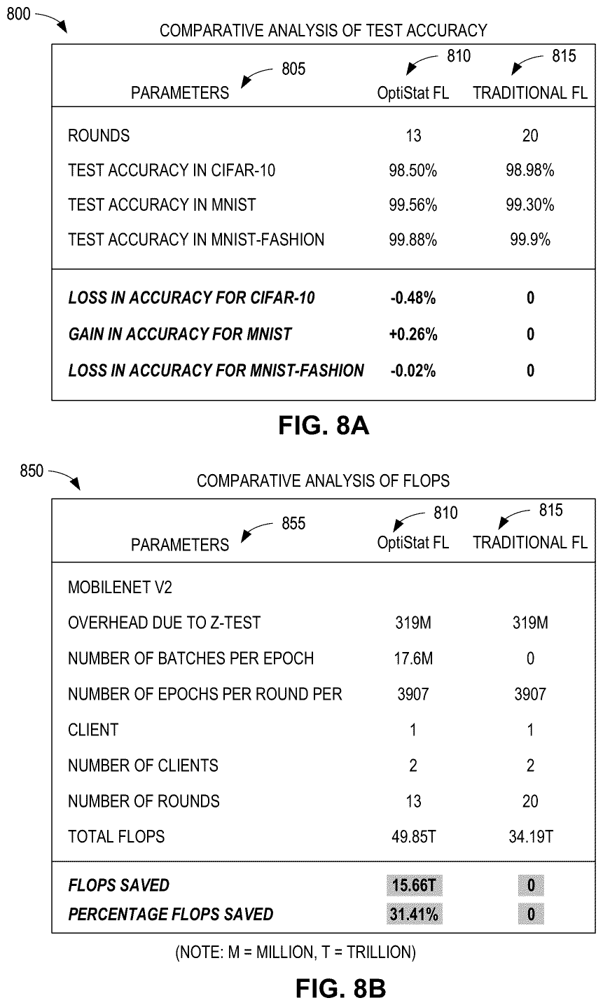

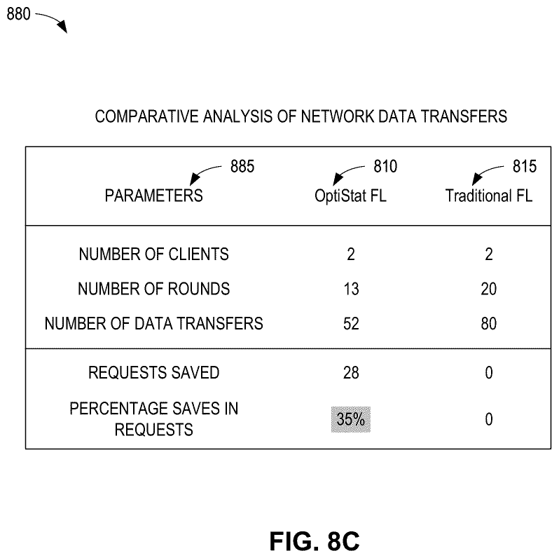

FIG. 8A illustrates an example comparative analysis 800 of test accuracy between a traditional federated learning method (e.g., Traditional FL) and federated learning using the statistically optimized learning framework (e.g., OptiStat FL) of FIG. 2. FIG. 8A includes example parameters 805 (e.g., rounds, test accuracies, loss in accuracy, gain in accuracy, etc.), example values obtained for OptiStat FL 810, and example values obtained for traditional FL 815. For example, due to the presence of a z-test-based adaptive early-stopping mechanism, OptiStat FL terminates aggregations at round 13 while traditional FL continues aggregations until the very last round (e.g., round 20). FIG. 8A shows the relative difference between testing accuracy achieved through OptiStat FL with respect to the traditional federated learning framework. In examples disclosed herein, OptiStat FL displays a minute dip in testing accuracy compared to the generic framework due to a lower number of aggregation rounds.

FIG. 8B illustrates an example comparative analysis 850 of differences in floating point operations (FLOPS) between a traditional federated learning method and federated learning using the statistically optimized learning framework of FIG. 2. FIG. 8B includes example parameters 855 (e.g., overhead due to z-test, number of batches per epoch, etc.), values obtained for OptiStat FL 810, and values obtained for traditional FL 815. FIG. 8B illustrates the FLOP difference between OptiStat FL (e.g., 49.85 trillion) and traditional FL (e.g., 34.19 trillion), emphasizing OptiStat FL's advantage. Despite the additional FLOPs used for z-test calculation, a substantial 15.66 trillion FLOPs are saved (e.g., 31.41% FLOPS saved) compared to conventional FL (e.g., 0% FLOPS saved), due to the presence of adaptive early-stopping criteria. Increasing the maximum iterations would yield more FLOP savings as model convergence typically occurs at approximately round 13. FLOP optimizations remain consistent as long as the number of clients and other parameters in federated learning remain constant.

FIG. 8C illustrates an example comparative analysis 880 of network data transfers between a traditional federated learning method and federated learning using the statistically optimized learning framework of FIG. 2. FIG. 8C includes example parameters 885 (e.g., number of clients, number of rounds, number of data transfers, etc.), values obtained for OptiStat FL 810, and values obtained for traditional FL 815. In the example of FIG. 8C, network data transfer requests are compared, showcasing OptiStat FL's advantage in reducing network load due to the presence of dynamic early-stopping criteria. For example, 35% of the transfer requests are saved when using OptiStat FL 810, as compared to 0% when using traditional FL 815.

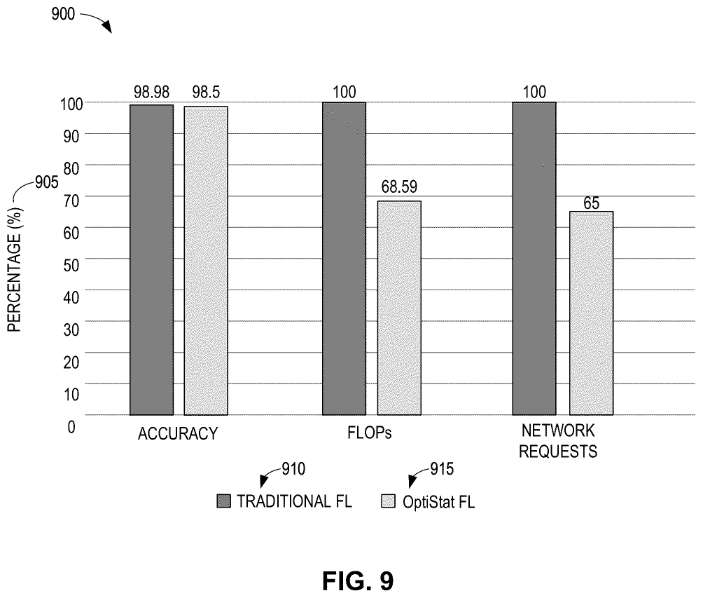

FIG. 9 illustrates an example graphical comparative analysis 900 of network and resource optimization between an example traditional federated learning method (e.g., traditional FL 910) and federated learning using the statistically optimized learning framework of FIG. 2 (e.g., OptiStat FL 915). FIG. 9 includes example percentages 905 associated with accuracy, FLOPs consumption, and network data transfer requests. In the example of FIG. 9, the OptiStat FL 915 achieves nearly the same accuracy as the traditional FL 910 but consumes 31.41% fewer FLOPs and raises 35% fewer network requests compared to conventional federated learning.

Overall, the experimental results of FIGS. 5A-5C, 6A-6D, 7, 8A-8C, and 9 show that methods and apparatus disclosed herein improve performance and efficiency of federated learning. For example, resource optimization experiments showed that OptiStat FL significantly reduced computational and network overhead by minimizing redundant aggregation rounds. Additionally, OptiStat FL achieved 31.41% fewer FLOPs and 35% less network load compared to traditional federated learning methods, resulting in significant resource savings. Furthermore, bias mitigation experiments demonstrated that aggregating collaborator models using the bias factor as weights through bias weighted federated averaging improved accuracy and resilience to biases. As such, discarding models solely based on biases can be avoided as this can negatively affect the global model's performance by reducing the number of knowledge sources. Bias mitigation techniques using the bias factor disclosed herein enhanced the aggregator model's immunity against biases. As such, incorporating bias mitigation and resource optimization techniques enhances the performance and efficiency of federated learning. These techniques improve accuracy, increase immunity to biases, and save computational resources, making federated learning more practical in real-world applications.

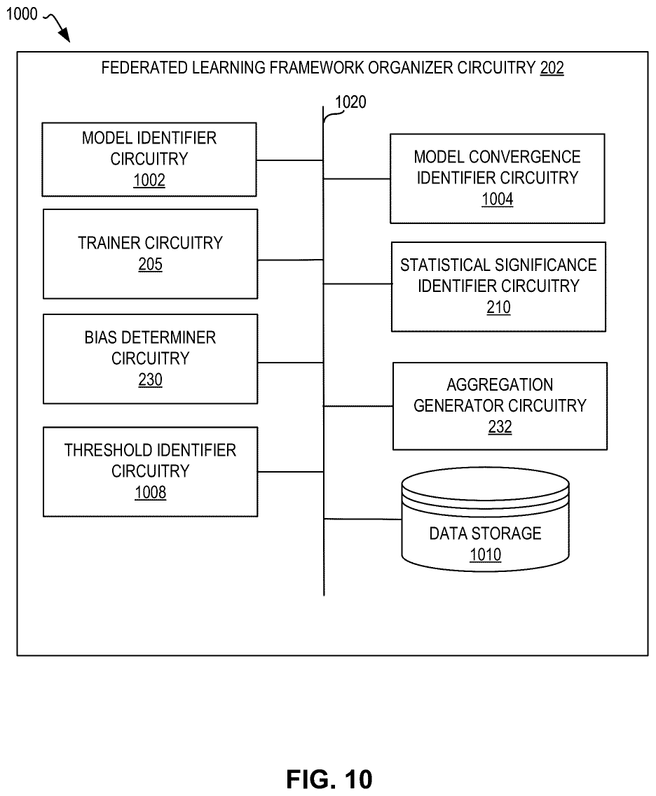

FIG. 10 is a block diagram 1000 of an example implementation of the federated learning framework organizer circuitry 202 of FIG. 2. The federated learning framework organizer circuitry 202 of FIG. 2 may be instantiated (e.g., creating an instance of, bring into being for any length of time, materialize, implement, etc.) by programmable circuitry such as a Central Processing Unit (CPU) executing first instructions. Additionally or alternatively, the federated learning framework organizer circuitry 202 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 10 may, thus, be instantiated at the same or different times. Some or all of the circuitry of FIG. 10 may be instantiated, for example, in one or more threads executing concurrently on hardware and/or in series on hardware. Moreover, in some examples, some or all of the circuitry of FIG. 10 may be implemented by microprocessor circuitry executing instructions and/or FPGA circuitry performing operations to implement one or more virtual machines and/or containers.

In the example of FIG. 10, the federated learning framework organizer circuitry 202 of FIG. 2 includes example model identifier circuitry 1002, example model convergence identifier circuitry 1004, example trainer circuitry 205, example statistical significance identifier circuitry 210, example bias determiner circuitry 230, example aggregation generator circuitry 232, example threshold identifier circuitry 1008, and example data storage 1010. In the example of FIG. 10, the model identifier circuitry 1002, the model convergence identifier circuitry 1004, the trainer circuitry 205, the statistical significance identifier circuitry 210, the bias determiner circuitry 230, the aggregation generator circuitry 232, and the threshold identifier circuitry 1008 are in communication via an example bus 1020.

The model identifier circuitry 1002 identifies a model of the federated learning framework. For example, the model identifier circuitry 1002 identifies a collaborator model (e.g., collaborator model 112 of FIG. 2) and/or an aggregator model (e.g., aggregator model 126 of FIG. 2). In some examples, the model identifier circuitry 1002 outputs a global model once aggregation of locally trained collaborator model(s) is completed. In some examples, the model identifier circuitry 1002 determines whether the collaborator model has been trained on the local dataset. In some examples, the model identifier circuitry 1002 determines a number and/or origin of collaborator models 112 used to obtain the aggregation model 126.

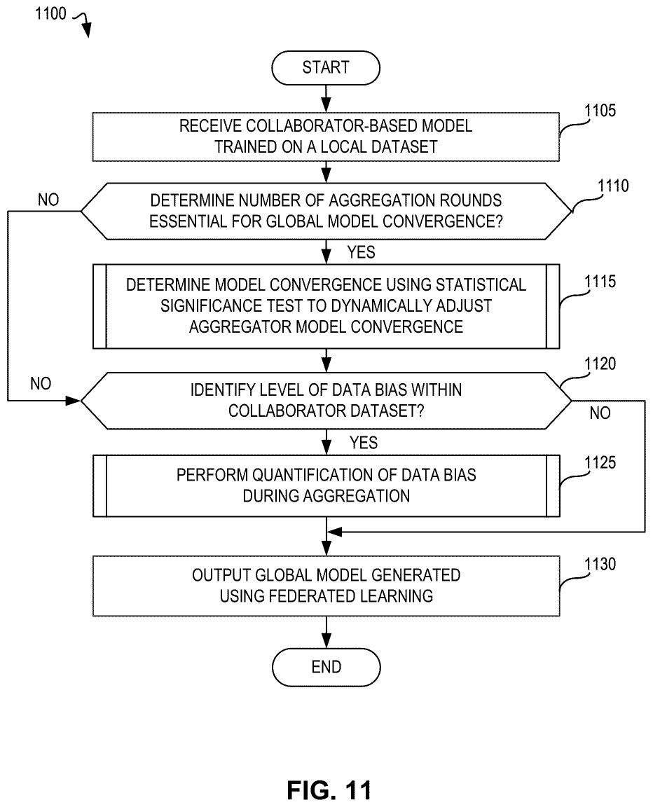

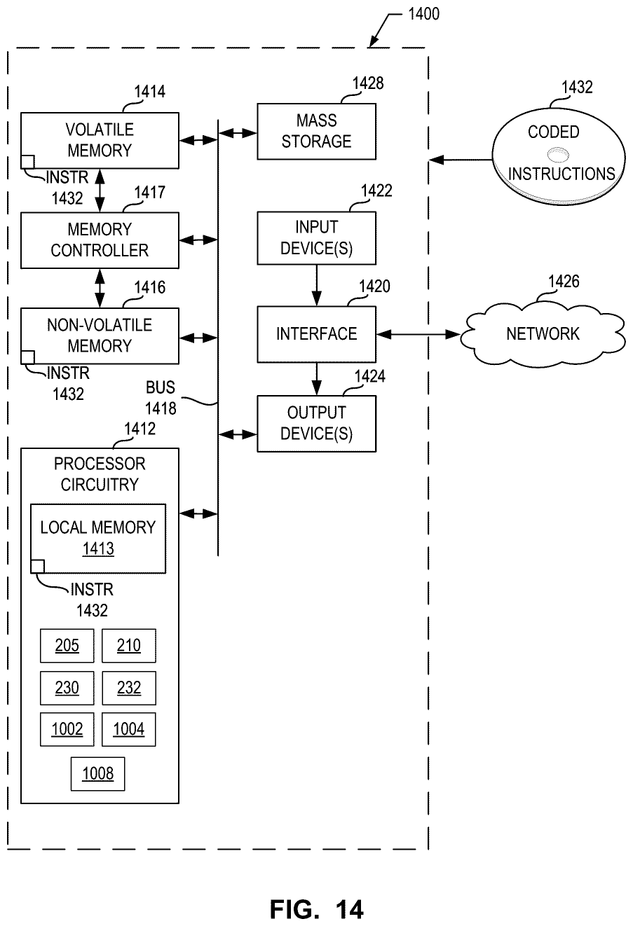

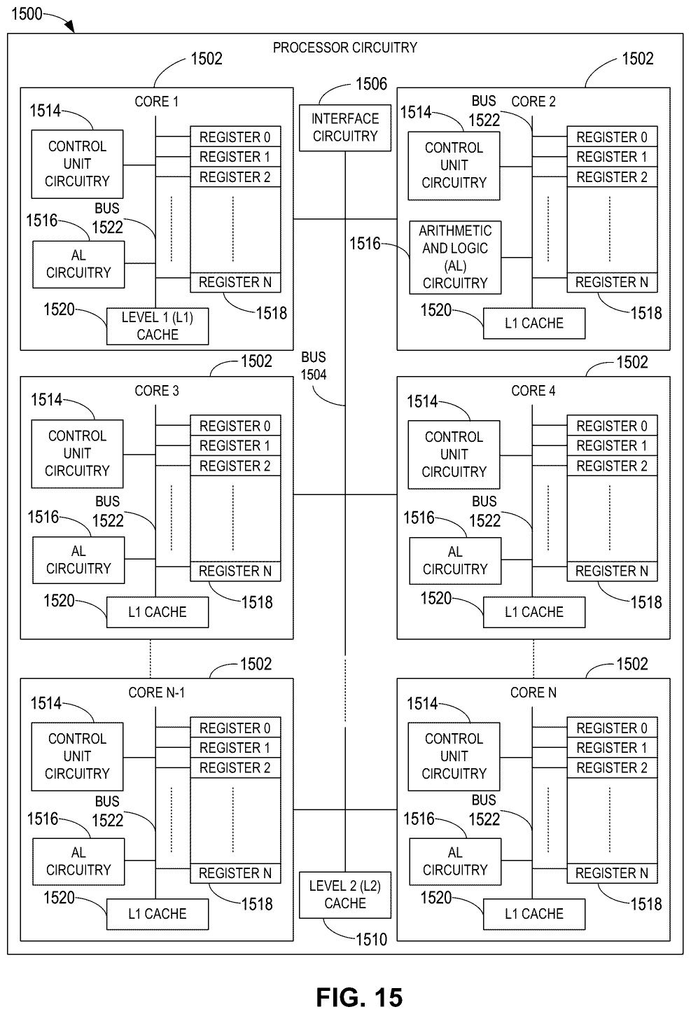

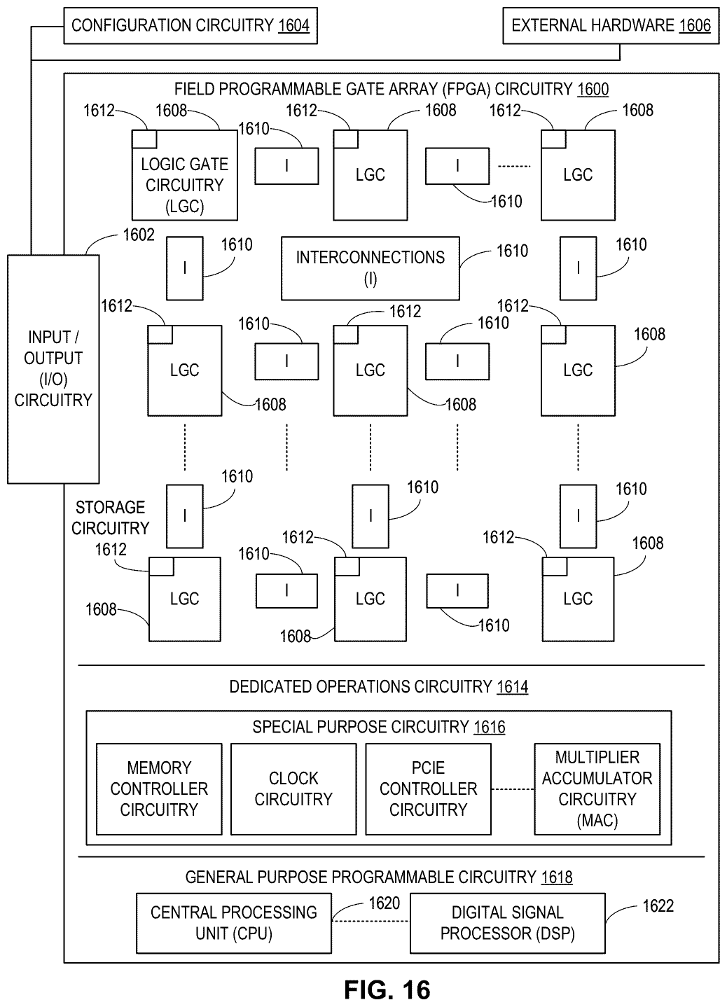

In some examples, the apparatus includes means for identifying a model. For example, the means for identifying a model may be implemented by model identifier circuitry 1002. In some examples, the model identifier circuitry 1002 may be instantiated by programmable circuitry such as the example programmable circuitry 1412 of FIG. 14. For instance, the model identifier circuitry 1002 may be instantiated by the example microprocessor 1500 of FIG. 15 executing machine executable instructions such as those implemented by at least block 1205 of FIG. 11. In some examples, the model identifier circuitry 1002 may be instantiated by hardware logic circuitry, which may be implemented by an ASIC, XPU, or the FPGA circuitry 1600 of FIG. 16 structured to perform operations corresponding to the machine readable instructions. Additionally or alternatively, the model identifier circuitry 1002 may be instantiated by any other combination of hardware, software, and/or firmware. For example, the model identifier circuitry 1002 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The model convergence identifier circuitry 1004 determines convergence of a global model based on a set number of aggregation rounds. For example, the model convergence identifier circuitry 1004 determines the aggregation rounds performed and/or the total number of aggregation rounds remaining for the global model to converge. In some examples, the model convergence identifier circuitry 1004 adjusts the aggregation rounds based on a z-test model, as described in connection with the statistical significance identifier circuitry 210 of FIG. 2.

In some examples, the apparatus includes means for identifying model convergence. For example, the means for identifying model convergence may be implemented by model convergence identifier circuitry 1004. In some examples, the model convergence identifier circuitry 1004 may be instantiated by programmable circuitry such as the example programmable circuitry 1412 of FIG. 14. For instance, the model convergence identifier circuitry 1004 may be instantiated by the example microprocessor 1500 of FIG. 15 executing machine executable instructions such as those implemented by at least block 1110 of FIG. 11. In some examples, the model convergence identifier circuitry 1004 may be instantiated by hardware logic circuitry, which may be implemented by an ASIC, XPU, or the FPGA circuitry 1600 of FIG. 16 structured to perform operations corresponding to the machine readable instructions. Additionally or alternatively, the model convergence identifier circuitry 1004 may be instantiated by any other combination of hardware, software, and/or firmware. For example, the model convergence identifier circuitry 1004 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The trainer circuitry 205 trains the collaborator model(s) 112 on local data. In some examples, the trainer circuitry 205 train the collaborator model prior to sending the model to the statistical significance identifier circuitry 210 of FIG. 2 to determine whether the model is rejected for aggregation rounds or accepted and sent for aggregation. In some examples, the trainer circuitry 205 trains the collaborator model using an existing global model as a starting point. For example, the trainer circuitry 205 can perform iterative training processes (e.g., using stochastic gradient descent, back propagation, and/or any other type of optimization technique specific to a set learning task associated with the model training).

In some examples, the apparatus includes means for training a collaborator model. For example, the means for training a collaborator model may be implemented by the trainer circuitry 205. In some examples, the trainer circuitry 205 may be instantiated by programmable circuitry such as the example programmable circuitry 1412 of FIG. 14. For instance, the trainer circuitry 205 may be instantiated by the example microprocessor 1500 of FIG. 15 executing machine executable instructions such as those implemented by at least block 1105 of FIG. 11. In some examples, the trainer circuitry 205 may be instantiated by hardware logic circuitry, which may be implemented by an ASIC, XPU, or the FPGA circuitry 1600 of FIG. 16 structured to perform operations corresponding to the machine readable instructions. Additionally or alternatively, the trainer circuitry 205 may be instantiated by any other combination of hardware, software, and/or firmware. For example, the trainer circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The statistical significance identifier circuitry 210 determines model convergence using a statistical significance test to dynamically adjust aggregation rounds associated with the federated learning framework. As described in connection with FIG. 2, the statistical significance identifier circuitry 210 identifies whether a p-value falls within the significance threshold (e.g., p-value<threshold). When the p-value falls within the threshold, the collaborator model is used as part of the aggregation rounds of the federated learning framework. Conversely, if the statistical significance identifier circuitry 210 determines that the z-test yields a p-value surpassing the significance threshold, the collaborator model is rejected, discontinuing the aggregation iteration chain. As described in more detail in connection with FIG. 2, the statistical significance identifier circuitry 210 uses a two-sample z-test to identify the p-value, such that a p-value of 1 corresponds to a 100% confidence in the null hypothesis (H₀), which signifies a 100% similarity between the collaborator and the aggregator models.

In some examples, the apparatus includes means for identifying statistical significance. For example, the means for identifying statistical significance may be implemented by the statistical significance identifier circuitry 210. In some examples, the statistical significance identifier circuitry 210 may be instantiated by programmable circuitry such as the example programmable circuitry 1412 of FIG. 14. For instance, the statistical significance identifier circuitry 210 may be instantiated by the example microprocessor 1500 of FIG. 15 executing machine executable instructions such as those implemented by at least block 1115 of FIG. 11. In some examples, the statistical significance identifier circuitry 210 may be instantiated by hardware logic circuitry, which may be implemented by an ASIC, XPU, or the FPGA circuitry 1600 of FIG. 16 structured to perform operations corresponding to the machine readable instructions. Additionally or alternatively, the statistical significance identifier circuitry 210 may be instantiated by any other combination of hardware, software, and/or firmware. For example, the statistical significance identifier circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The bias determiner circuitry 230 identifies a bias factor (β) to quantify data bias. As described in connection with FIG. 2, the bias determiner circuitry 230 also identifies boundary conditions associated with the bias factor. For example, the bias determiner circuitry 230 determines that the value of the bias factor lies between [0,1], where 0 denotes the ideal scenario of a completely balanced dataset and 1 depicts the presence of a strong bias.

In some examples, the apparatus includes means for determining data bias. For example, the means for determining data bias may be implemented by the bias determiner circuitry 230. In some examples, the bias determiner circuitry 230 may be instantiated by programmable circuitry such as the example programmable circuitry 1412 of FIG. 14. For instance, the bias determiner circuitry 230 may be instantiated by the example microprocessor 1500 of FIG. 15 executing machine executable instructions such as those implemented by at least block 1125 of FIG. 11. In some examples, the bias determiner circuitry 230 may be instantiated by hardware logic circuitry, which may be implemented by an ASIC, XPU, or the FPGA circuitry 1600 of FIG. 16 structured to perform operations corresponding to the machine readable instructions. Additionally or alternatively, the bias determiner circuitry 230 may be instantiated by any other combination of hardware, software, and/or firmware. For example, the bias determiner circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The aggregation generator circuitry 232 uses the bias factor to regulate bias propagation from the collaborator model(s) (e.g., collaborator model 112 of FIG. 2) to the aggregator model (e.g., aggregator model 126 of FIG. 2). The aggregation generator circuitry 232 identifies aggregation algorithms based on the bias factor, including (1) bias thresholding, (2) a bias weighted federated averaging (FedAvg)-based algorithm, and (3) hybrid aggregation, as described in more detail in connection with FIG. 2. For example, the aggregation generator circuitry 232 accepts collaborator model(s) with bias factors within a given threshold T for aggregation (e.g., β≤T), while collaborator model(s) exceeding the threshold (e.g., β>T) are rejected and replaced with the previously aggregated model.

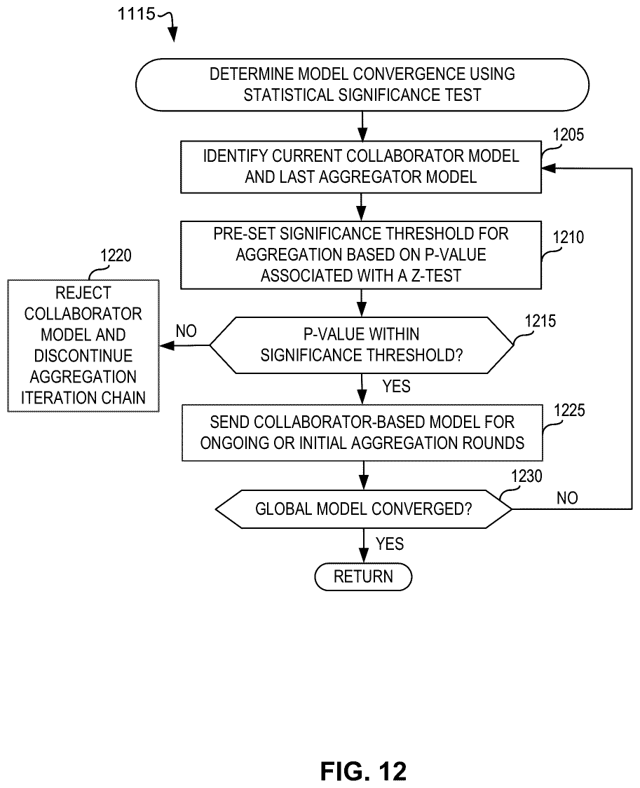

In some examples, the apparatus includes means for aggregating models. For example, the means for aggregating models may be implemented by the aggregation generator circuitry 232. In some examples, the aggregation generator circuitry 232 may be instantiated by programmable circuitry such as the example programmable circuitry 1412 of FIG. 14. For instance, the aggregation generator circuitry 232 may be instantiated by the example microprocessor 1500 of FIG. 15 executing machine executable instructions such as those implemented by at least block 1230 of FIG. 12. In some examples, the aggregation generator circuitry 232 may be instantiated by hardware logic circuitry, which may be implemented by an ASIC, XPU, or the FPGA circuitry 1600 of FIG. 16 structured to perform operations corresponding to the machine readable instructions. Additionally or alternatively, the aggregation generator circuitry 232 may be instantiated by any other combination of hardware, software, and/or firmware. For example, the aggregation generator circuitry 232 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The threshold identifier circuitry 1008 sets threshold(s) associated with the federated learning framework of FIG. 2. For example, the threshold identifier circuitry 1008 identifies the significance threshold used by the statistical significance identifier circuitry 210 to determine whether to accept or reject a collaborator model. The threshold identifier circuitry 1008 also identifies the bias factor threshold used by the aggregation generator circuitry 232 to accept or reject a collaborator model for aggregation.

In some examples, the apparatus includes means for identifying a threshold. For example, the means for identifying a threshold may be implemented by the threshold identifier circuitry 1008. In some examples, the threshold identifier circuitry 1008 may be instantiated by programmable circuitry such as the example programmable circuitry 1412 of FIG. 14. For instance, the threshold identifier circuitry 1008 may be instantiated by the example microprocessor 1500 of FIG. 15 executing machine executable instructions such as those implemented by at least block 1210 of FIG. 12. In some examples, the threshold identifier circuitry 1008 may be instantiated by hardware logic circuitry, which may be implemented by an ASIC, XPU, or the FPGA circuitry 1600 of FIG. 16 structured to perform operations corresponding to the machine readable instructions. Additionally or alternatively, the threshold identifier circuitry 1008 may be instantiated by any other combination of hardware, software, and/or firmware. For example, the threshold identifier circuitry 1008 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data storage 1010 can be used to store any information associated with the model identifier circuitry 1002, the model convergence identifier circuitry 1004, the trainer circuitry 205, the statistical significance identifier circuitry 210, the bias determiner circuitry 230, the aggregation generator circuitry 232, and the threshold identifier circuitry 1008. The example data storage 1010 of the illustrated example of FIG. 10 can be implemented by any memory, storage device and/or storage disc for storing data such as flash memory, magnetic media, optical media, etc. Furthermore, the data stored in the example data storage 1010 can be in any data format such as binary data, comma delimited data, tab delimited data, structured query language (SQL) structures, image data, etc.

While an example manner of implementing the federated learning framework organizer circuitry 202 of FIG. 2 is illustrated in FIG. 10, one or more of the elements, processes and/or devices illustrated in FIG. 10 may be combined, divided, re-arranged, omitted, eliminated and/or implemented in any other way. Further, the example model identifier circuitry 1002, example model convergence identifier circuitry 1004, example trainer circuitry 205, example statistical significance identifier circuitry 210, example bias determiner circuitry 230, example aggregation generator circuitry 232, example threshold identifier circuitry 1008, and/or, more generally, the example federated learning framework organizer circuitry 202 of FIG. 2 may be implemented by hardware, software, firmware and/or any combination of hardware, software and/or firmware. Thus, for example, any of the example model identifier circuitry 1002, example model convergence identifier circuitry 1004, example trainer circuitry 205, example statistical significance identifier circuitry 210, example bias determiner circuitry 230, example aggregation generator circuitry 232, example threshold identifier circuitry 1008, and/or, more generally, the example federated learning framework organizer circuitry 202 of FIG. 2 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the federated learning framework organizer circuitry 202 of FIG. 2 may include one or more elements, processes, and/or devices in addition to, or instead of, those illustrated in FIG. 10, and/or may include more than one of any or all of the illustrated elements, processes and devices.

Flowcharts representative of example machine readable instructions, which may be executed by programmable circuitry to implement and/or instantiate the federated learning framework organizer circuitry 202 of FIG. 2 and/or representative of example operations which may be performed by programmable circuitry to implement and/or instantiate the federated learning framework organizer circuitry 202 of FIG. 2, are shown in FIGS. 11-13. The machine readable instructions may be one or more executable programs or portion(s) of one or more executable programs for execution by programmable circuitry, such as the programmable circuitry 1412 shown in the example processor platform 1400 discussed below in connection with FIG. 14 and/or may be one or more function(s) or portion(s) of functions to be performed by the example programmable circuitry (e.g., an FPGA) discussed below in connection with FIGS. 15 and/or 16. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 11-13, many other methods of implementing the example federated learning framework organizer circuitry 202 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 11-13 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, and/or activities, the phrase “at least one of A and B” is intended to refer to implementations including any of (1) at least one A, (2) at least one B, or (3) at least one A and at least one B. Similarly, as used herein in the context of describing the performance or execution of processes, instructions, actions, and/or activities, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

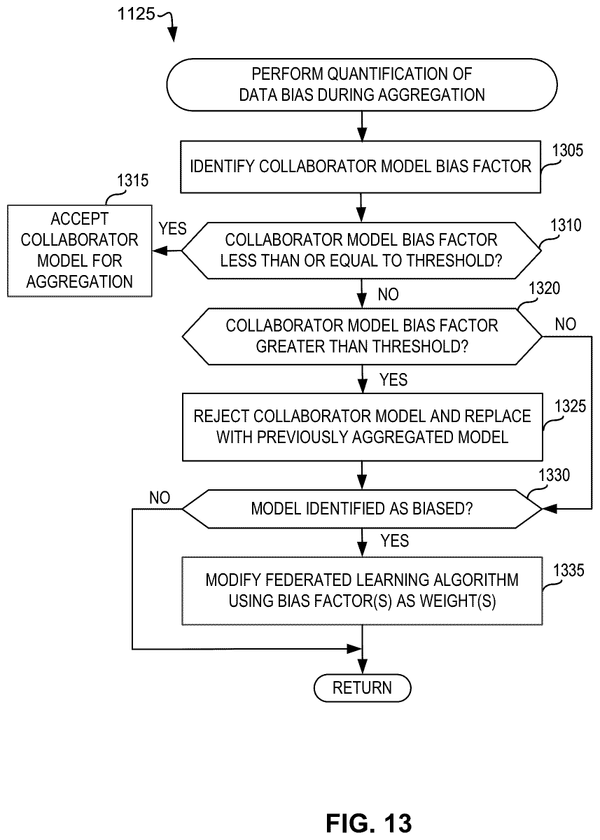

FIG. 11 is a flowchart representative of example machine readable instructions and/or example operations 1100 that may be executed, instantiated, and/or performed by programmable circuitry to implement the example federated learning framework organizer circuitry 202 of FIG. 2. The machine readable instructions and/or the operations 1100 of FIG. 11 begin at block 1105, at which the model identifier circuitry 1002 receives a collaborator-based model trained on a local dataset, at block 1105. In some examples, the collaborator model is based on a previously generated global model, as shown in connection with FIG. 2. The model convergence identifier circuitry 1004 determines whether the model has converged, a total number of aggregation rounds performed, and/or a total number of aggregation rounds that are essential for global model convergence, at block 1110. If the global model has not converged, the statistical significance identifier circuitry 210 determines model convergence using a statistical significance test to dynamically adjust the aggregator model convergence, at block 1115. As described in more detail in connection with FIG. 12, the statistical significance identifier circuitry 210 identifies model convergence based on the comparison of a p-value to a significance threshold. In some examples, the bias determiner circuitry 230 identifies a level of data bias within the collaborator dataset, at block 1120. As described in connection with FIG. 13, the bias determiner circuitry 230 identifies a bias factor and compares the bias factor to a threshold to determine whether the collaborator model includes data bias. For example, the bias determiner circuitry 230 performs quantification of the data bias during aggregation, at block 1125. Once the global model has converged, the model identifier circuitry 1002 outputs the converged global model generated using the federated learning framework of FIG. 2, at block 1130.

FIG. 12 is a flowchart representative of example machine readable instructions and/or example operations 1100 that may be executed, instantiated, and/or performed by programmable circuitry to implement the example federated learning framework organizer circuitry 202 of FIG. 2. The machine readable instructions and/or the operations 1115 of FIG. 12 begin at block 1205, at which the model identifier circuitry 1002 identifies a current collaborator model (e.g., collaborator model 112 of FIG. 2) and the last aggregator model (e.g., aggregator model 126 of FIG. 2). The threshold identifier circuitry 1008 presets a significance threshold for aggregation based on a p-value associated with a z-test, at block 1210. For example, the statistical significance identifier circuitry 210 identifies the p-value associated with a null hypothesis (H₀) and an alternate hypothesis (Hₐ), as described in more detail in connection with FIG. 2. When evaluating a collaborator model for inclusion in the aggregation iteration chain, the statistical significance identifier circuitry 210 determines whether the p-value identified with the collaborator model is within the significance threshold, at block 1215. If the collaborator is within the significance threshold, the statistical significance identifier circuitry 210 sends the collaborator model for ongoing or initial aggregation round(s), at block 1225. If the collaborator model exceeds the significance threshold, the statistical significance identifier circuitry 210 rejects the collaborator model and the aggregation generator circuitry 232 discontinues the aggregation iteration chain, at block 1220. If the aggregation rounds proceed, the model convergence identifier circuitry 1004 determines whether the global model has converged, at block 1230. If the global model has not converged, subsequent collaborator models are identified and assessed using the p-value comparison to the significance threshold, until the model convergence identifier circuitry 1004 identifies that the global model has converged.

FIG. 13 is a flowchart representative of example machine readable instructions and/or example operations 1100 that may be executed, instantiated, and/or performed by programmable circuitry to implement the example federated learning framework organizer circuitry 202 of FIG. 2. The machine readable instructions and/or the operations 1125 of FIG. 13 begin at block 1305, at which the bias determiner circuitry 230 identifies a bias factor associated with the collaborator model, as described in more detail in connection with FIG. 2. The threshold identifier circuitry 1008 determines whether the bias factor is less than or equal to the bias factor threshold, at block 1310. If the bias factor is less than or equal to the bias factor threshold, the aggregation generator circuitry 232 accepts the collaborator model for aggregation, at block 1315. If the bias factor is greater than the bias threshold, at block 1320, the aggregation generator circuitry 232 rejects the collaborator model and replaces the collaborator model with a previously aggregated model, at block 1325. In some examples, if the bias determiner circuitry 230 determines that the collaborator model is biased, at block 1330, the aggregation generator circuitry 232 modifies the federated learning algorithm using the bias factor(s) as weight(s), at block 1335. For example, the aggregation generator circuitry 232 assigns higher weights to collaborator models with lower bias, contributing more to the aggregation, while collaborator models with higher bias receive lower weights, as described in more detail in connection with FIG. 2.

FIG. 14 is a block diagram of an example programmable circuitry platform 1400 structured to execute and/or instantiate the example machine-readable instructions and/or the example operations of FIGS. 11, 12 and/or 13 to implement the example federated learning framework organizer circuitry 202 of FIG. 2. The programmable circuitry platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs microprocessors, CPUs, GPUs, DSPs, and/or microcontrollers from any desired family or manufacturer. The programmable circuitry 1412 may be implemented by one or more semiconductor based (e.g., silicon based) devices. In this example, the processor circuitry 1412 implements the model identifier circuitry 1002, model convergence identifier circuitry 1004, trainer circuitry 205, statistical significance identifier circuitry 210, bias determiner circuitry 230, aggregation generator circuitry 232, and threshold identifier circuitry 1008.

The programmable circuitry 1412 of the illustrated example includes a local memory 1413 (e.g., a cache, registers, etc.). The programmable circuitry 1412 of the illustrated example is in communication with a main memory including a volatile memory 1414 and a non-volatile memory 1416 by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1424 are also connected to the interface circuitry 1420 of the illustrated example. The output devices 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1400 of the illustrated example also includes one or more mass storage devices 1428 to store software and/or data. Examples of such mass storage devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1432, which may be implemented by the machine readable instructions of FIGS. 11, 12 and/or 13, may be stored in the mass storage device 1428, in the volatile memory 1414, in the non-volatile memory 1416, and/or on at least one non-transitory computer readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general purpose microprocessor (e.g., general purpose microprocessor circuitry). The microprocessor 1500 executes some or all of the machine readable instructions of the flowchart of FIGS. 11, 12 and/or 13 to effectively instantiate the circuitry of FIG. 10 logic circuits to perform the operations corresponding to those machine readable instructions. In some such examples, the circuitry of FIG. 10 is instantiated by the hardware circuits of the microprocessor 1500 in combination with the instructions. For example, the microprocessor 1500 may implement multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowcharts of FIGS. 11, 12 and/or 13.

The cores 1502 may communicate by a first example bus 1504. In some examples, the first bus 1504 may implement a communication bus to effectuate communication associated with one(s) of the cores 1502. For example, the first bus 1504 may implement at least one of an Inter-Integrated Circuit (I2C) bus, a Serial Peripheral Interface (SPI) bus, a PCI bus, or a PCIe bus. Additionally or alternatively, the first bus 1504 may implement any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2_cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the L1 cache 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer-based operations. In other examples, the AL circuitry 1516 also performs floating-point operations. In yet other examples, the AL circuitry 1516 may include first AL circuitry that performs integer-based operations and second AL circuitry that performs floating point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

FIG. 16 is a block diagram of another example implementation of the programmable circuitry of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine readable instructions represented by the flowcharts of FIGS. 11, 12 and/or 13 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 11, 12 and/or 13. In particular, the FPGA 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 11, 12 and/or 13. As such, the FPGA circuitry 1600 may be configured and/or structured to effectively instantiate some or all of the operations/functions corresponding to the machine readable instructions of the flowcharts of FIGS. 11, 12 and/or 13 as dedicated logic circuits to perform the operations/functions corresponding to those software instructions in a dedicated manner analogous to an ASIC. Therefore, the FPGA circuitry 1600 may perform the operations/functions corresponding to the some or all of the machine readable instructions of FIGS. 11, 12 and/or 13 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine readable instructions of FIGS. 11, 12 and/or 13 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 16. Therefore, the programmable circuitry 1412 of FIG. 14 may additionally be implemented by combining at least the example microprocessor 1500 of FIG. 15 and the example FPGA circuitry 1600 of FIG. 16. In some such hybrid examples, one or more cores 1602 of FIG. 16 may execute a first portion of the machine readable instructions represented by the flowchart(s) of FIGS. 11, 12 and/or 13 to perform first operation(s)/function(s), the FPGA circuitry 1600 of FIG. 16 may be configured and/or structured to perform second operation(s)/function(s) corresponding to a second portion of the machine readable instructions represented by the flowcharts of FIGS. 11, 12 and/or 13, and/or an ASIC may be configured and/or structured to perform third operation(s)/function(s) corresponding to a third portion of the machine readable instructions represented by the flowcharts of FIGS. 11, 12 and/or 13.

It should be understood that some or all of the circuitry of FIG. 2 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIG. 10 may be instantiated, for example, in one or more threads executing concurrently and/or in series. For example, the microprocessor 1500 of FIG. 15 may execute machine readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIG. 10 may be implemented within one or more virtual machines and/or containers executing on the microprocessor 1500 of FIG. 15.

In some examples, the programmable circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1412 of FIG. 14 which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

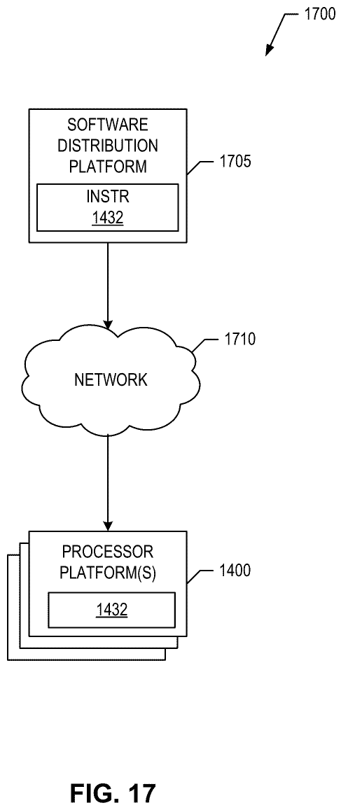

A block diagram illustrating an example software distribution platform 1705 to distribute software such as the example machine readable instructions 1432 of FIG. 14 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1432, which may correspond to the example machine readable instructions of FIGS. 11, 12 and/or 13, as described above. The one or more servers of the example software distribution platform 1705 are in communication with an example network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1705. For example, the software, which may correspond to the example machine readable instructions of FIGS. 11, 12 and/or 13, may be downloaded to the example programmable circuitry platform 1400, which is to execute the machine readable instructions 1432 to implement the federated learning framework organizer circuitry 202 of FIG. 2. In some examples, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein introduce a statistically optimized learning framework offering bias mitigation. In examples disclosed herein, methods and apparatus disclosed herein identify aggregation-based rounds essential for a global model to converge. In examples disclosed herein, a mathematical factor is introduced that precisely quantifies the level of data bias within a collaborator dataset while upholding stringent data privacy standards. Additionally, computational resource efficiency is maximized while preserving model metrics with either no degradation or minimal degradation. Methods and apparatus disclosed herein introduce a statistical early stopping criterion to detect model convergence, achieving a reduction in the usage of Floating Point Operations (FLOPs) and overall network requests, as compared to that of conventional federated learning frameworks. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for a statistically optimized learning framework offering bias mitigation are disclosed herein. Further examples and combinations thereof include the following:

Example 1 includes an apparatus, comprising interface circuitry, machine-readable instructions, and at least one processor circuit to be programmed by the machine-readable instructions to send a global model to one or more collaborator models, the one or more collaborator models training on a local dataset associated with a collaborator model, receive one or more collaborator models trained on the local dataset, compute a similarity measurement between the global model and at least one collaborator model, determine aggregation for the global model based on the computed similarity measurement, aggregate one or more collaborator models based on the determined aggregation, and update the global model based on the aggregation.

Example 2 includes the apparatus of example 1, wherein one or more of the at least one processor circuit is to perform the similarity measurement based on an average value comparison between the collaborator model and the global model.

Example 3 includes the apparatus of example 2, wherein one or more of the at least one processor circuit is to set a significance threshold for aggregation based on the average value comparison, the average value comparison a two-sample Z-test.

Example 4 includes the apparatus of example 3, wherein one or more of the at least one processor circuit is to identify a contribution of the collaborator model as statistically significant when the contribution of the collaborator model falls within the significance threshold.

Example 5 includes the apparatus of example 1, wherein one or more of the at least one processor circuit is to regulate data bias propagation by identifying a threshold of a bias factor, the collaboration model within the bias factor accepted for aggregation.

Example 6 includes the apparatus of example 5, wherein one or more of the at least one processor circuit is to modify the collaborator model using the bias factor, where a first collaborator model with a lower bias receives higher weights and a second collaborator model with a higher bias receives lower weights.

Example 7 includes the apparatus of example 6, wherein one or more of the at least one processor circuit is to add the first collaborator model with the lower bias to the aggregation of collaborator models.

Example 8 includes a method comprising send a global model to one or more collaborator models, the one or more collaborator models training on a local dataset associated with a collaborator model, receive, by at least one processor circuit programmed by at least one instruction, one or more collaborator models trained on the local dataset, compute, by one or more of the at least one processor circuit, a similarity measurement between the global model and at least one collaborator model, determine aggregation for the global model based on the computed similarity measurement, aggregate one or more collaborator models based on the determined aggregation, and update the global model based on the aggregation.

Example 9 includes the method of example 8, further including

performing the similarity measurement based on an average value comparison between the collaborator model and the global model.

Example 10 includes the method of example 9, further including setting a significance threshold for aggregation based on the average value comparison, the average value comparison a two-sample Z-test.

Example 11 includes the method of example 10, further including identifying a contribution of the collaborator model as statistically insignificant when the contribution of the collaborator model surpasses the significance threshold.

Example 12 includes the method of example 11, further including regulating data bias propagation by identifying a threshold of a bias factor, the collaboration model within the bias factor accepted for aggregation.

Example 13 includes the method of example 12, further including modifying the collaborator model using the bias factor, where a first collaborator model with a lower bias receives higher weights and a second collaborator model with a higher bias receives lower weights.

Example 14 includes the method of example 13, further including adding the first collaborator model with the lower bias to the aggregation of collaborator models.

Example 15 includes At least one non-transitory machine-readable medium comprising machine-readable instructions to cause at least one processor circuit to at least send a global model to one or more collaborator models, the one or more collaborator models training on a local dataset associated with a collaborator model, receive one or more collaborator models trained on the local dataset, compute a similarity measurement between the global model and at least one collaborator model, determine aggregation for the global model based on the computed similarity measurement, aggregate one or more collaborator models based on the determined aggregation, and update the global model based on the aggregation.

Example 16 includes the at least one non-transitory machine-readable medium of example 15, wherein the machine-readable instructions are to cause one or more of the at least one processor circuit to perform the similarity measurement based on an average value comparison between the collaborator model and the global model.

Example 17 includes the at least one non-transitory machine-readable medium of example 16, wherein the machine-readable instructions are to cause one or more of the at least one processor circuit to set a significance threshold for aggregation based on the average value comparison, the average value comparison a two-sample Z-test.

Example 18 includes the at least one non-transitory machine-readable medium of example 17, wherein the machine-readable instructions are to cause one or more of the at least one processor circuit to identify a contribution of the collaborator model as statistically significant when the contribution of the collaborator model falls within the significance threshold.

Example 19 includes the at least one non-transitory machine-readable medium of example 15, wherein the machine-readable instructions are to cause one or more of the at least one processor circuit to identify a threshold of a bias factor, the collaboration model within the bias factor accepted for aggregation.

Example 20 includes the at least one non-transitory machine-readable medium of example 19, wherein the machine-readable instructions are to cause one or more of the at least one processor circuit to modify the collaborator model using the bias factor, where a first collaborator model with a lower bias receives higher weights and a second collaborator model with a higher bias receives lower weights.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
send a global model to one or more collaborator models, the one or more collaborator models training on a local dataset associated with a collaborator model;
receive one or more collaborator models trained on the local dataset;
compute a similarity measurement between the global model and at least one collaborator model;
determine aggregation for the global model based on the computed similarity measurement;
aggregate one or more collaborator models based on the determined aggregation; and
update the global model based on the aggregation.

2. The apparatus of claim 1, wherein one or more of the at least one processor circuit is to perform the similarity measurement based on an average value comparison between the collaborator model and the global model.

3. The apparatus of claim 2, wherein one or more of the at least one processor circuit is to set a significance threshold for aggregation based on the average value comparison, the average value comparison a two-sample Z-test.

4. The apparatus of claim 3, wherein one or more of the at least one processor circuit is to identify a contribution of the collaborator model as statistically significant when the contribution of the collaborator model falls within the significance threshold.

5. The apparatus of claim 1, wherein one or more of the at least one processor circuit is to regulate data bias propagation by identifying a threshold of a bias factor, the collaboration model within the bias factor accepted for aggregation.

6. The apparatus of claim 5, wherein one or more of the at least one processor circuit is to modify the collaborator model using the bias factor, where a first collaborator model with a lower bias receives higher weights and a second collaborator model with a higher bias receives lower weights.

7. The apparatus of claim 6, wherein one or more of the at least one processor circuit is to add the first collaborator model with the lower bias to the aggregation of collaborator models.

8. A method comprising:
send a global model to one or more collaborator models, the one or more collaborator models training on a local dataset associated with a collaborator model;
receive, by at least one processor circuit programmed by at least one instruction, one or more collaborator models trained on the local dataset;
compute, by one or more of the at least one processor circuit, a similarity measurement between the global model and at least one collaborator model;
determine aggregation for the global model based on the computed similarity measurement;
aggregate one or more collaborator models based on the determined aggregation; and
update the global model based on the aggregation.

9. The method of claim 8, further including performing the similarity measurement based on an average value comparison between the collaborator model and the global model.

10. The method of claim 9, further including setting a significance threshold for aggregation based on the average value comparison, the average value comparison a two-sample Z-test.

11. The method of claim 10, further including identifying a contribution of the collaborator model as statistically insignificant when the contribution of the collaborator model surpasses the significance threshold.

12. The method of claim 11, further including regulating data bias propagation by identifying a threshold of a bias factor, the collaboration model within the bias factor accepted for aggregation.

13. The method of claim 12, further including modifying the collaborator model using the bias factor, where a first collaborator model with a lower bias receives higher weights and a second collaborator model with a higher bias receives lower weights.

14. The method of claim 13, further including adding the first collaborator model with the lower bias to the aggregation of collaborator models.

15. At least one non-transitory machine-readable medium comprising machine-readable instructions to cause at least one processor circuit to at least:
send a global model to one or more collaborator models, the one or more collaborator models training on a local dataset associated with a collaborator model;
receive one or more collaborator models trained on the local dataset;
compute a similarity measurement between the global model and at least one collaborator model;
determine aggregation for the global model based on the computed similarity measurement;
aggregate one or more collaborator models based on the determined aggregation; and
update the global model based on the aggregation.

16. The at least one non-transitory machine-readable medium of claim 15, wherein the machine-readable instructions are to cause one or more of the at least one processor circuit to perform the similarity measurement based on an average value comparison between the collaborator model and the global model.

17. The at least one non-transitory machine-readable medium of claim 16, wherein the machine-readable instructions are to cause one or more of the at least one processor circuit to set a significance threshold for aggregation based on the average value comparison, the average value comparison a two-sample Z-test.

18. The at least one non-transitory machine-readable medium of claim 17, wherein the machine-readable instructions are to cause one or more of the at least one processor circuit to identify a contribution of the collaborator model as statistically significant when the contribution of the collaborator model falls within the significance threshold.

19. The at least one non-transitory machine-readable medium of claim 15, wherein the machine-readable instructions are to cause one or more of the at least one processor circuit to identify a threshold of a bias factor, the collaboration model within the bias factor accepted for aggregation.

20. The at least one non-transitory machine-readable medium of claim 19, wherein the machine-readable instructions are to cause one or more of the at least one processor circuit to modify the collaborator model using the bias factor, where a first collaborator model with a lower bias receives higher weights and a second collaborator model with a higher bias receives lower weights.
